(19) United States
(12) Patent Application Publication
(10) Pub. No.: US 2020/0226293 A1
(43) Pub. Date: Jul. 16, 2020

(54) Anti-Tampering Switch for Electronic Access Control Readers

(71) Applicant: Bryan Buenaventura, San Mateo, CA (US)

(72) Inventor: Bryan Buenaventura, San Mateo, CA (US)

(21) Appl. No.: 16/246,502

(22) Filed: Jan. 13, 2019

(51) Int. Cl. G06F 21/70

(52) U.S. Cl. CPC G06F 21/70; G06F 1/24

(57) ABSTRACT

An anti-tampering device for electronic access control systems to prevent man-in-the-middle attacks by severing data & power connections from the access panel to the controller panel until the switch can be reset to normal once the attack has been averted. The device comprises of a chipset that can be installed inside the access system controller panel enclosure of the card reader system, in a secured environment within the protected premises.

### CROSS REFERENCE TO RELATED APPLICATIONS

This Non-Provisional Application claims priority to U.S. Provisional Application No. 62/617,300 filed on Jan. 15, 2018, and U.S. Provisional Application No. 62/690,485 filed on Jun. 27, 2018.

### STATEMENT REGARDING FEDERALLY SPONSORED RESEARCH AND DEVELOPMENT

None.

### FIELD OF THE INVENTION

The present invention relates to an anti-tampering device for electronic access control readers.

### BACKGROUND

The Wiegand protocol is the predominant method by which access control card readers communicate with upstream devices such as local controllers, access control panels and host computer systems. Because of the popularity and almost universal support of the Wiegand protocol in access control panels, other devices besides access control readers are also available that support the Wiegand protocol. Such devices include biometric-based devices such as fingerprint, hand-geometry, iris, facial recognition, and vein scan.

Both the electrical and logical aspects of the Wiegand communication protocol are codified in the Security Industry Association (SIA) standard AC-01 entitled “Access Control Standard Protocol for the 26-Bit Wiegand Reader Interface”, the entire contents of which are incorporated herein by this reference in their entirety and will henceforth be referred to as the “SIA standard”.

Subsequent to the issuing of this standard, both the electrical and logical portions of the standard have been used to transmit bit stream messages, often called formats, longer than 26 bits. 35- and 37-bit formats are found widely and the US Government's PIV standard defines some formats of up to 300 bits. The evolution of upstream devices and middleware to use these longer formats has been slow and is still taking place.

Although other methods are utilized for carrying the informational aspects of the Wiegand protocol over communication bearers such as RS-485, F/2F, and various Internet protocols such as TCP/IP and UDP, none has achieved the widespread usage that Wiegand has in the security and access control market segments This is primarily because each manufacturer utilizes their own proprietary protocols even when using standardized communication bearers such as TCP/IP.

The widespread adoption of the Wiegand protocol is due to several advantages with the Wiegand protocol being that its implementation in devices is very economical and that it allows very long cable runs which, depending on the gauge of the wire used, can be as long as 500 feet.

The electrical aspect of the Wiegand protocol uses five wires. Two of these wires are used to provide power to the reader. The remaining three wires are used for data communication and signaling and use the open collector electrical standard, which means that the circuit acts as either an infinite resistance or a short circuit to ground. Typically the upstream device employs a pull-up resistor, which keeps the signal at a high voltage (+5) when it is in the open circuit state. When the signal is asserted, the output is forced to 0 volts. Note that the open state (+5 volts) represents a data value of zero and the asserted state (0 volts) represents the data value of one. This is generally referred to as an “active low” configuration where the active state is the low voltage.

Two of the three data communication and signaling wires are used by the reader to transmit data to an upstream device e.g., control panel, intermediate device, routing device, lock control mechanism, computing platform, host, or the like. These two wires are referred to as DATAO and DATA1. As the names suggest, the DATAO signal transmits the “0” bits of the data stream to the upstream device, and the DATA1 signal transmits the “1” bits.

The third data communication and signaling wire is used by the upstream device to signal the reader. This wire is called LEDCTL because it is often used by the upstream device to control a light-emitting diode (LED) in the reader and provides feedback to the card holder.

As popular as the Wiegand interface has become, it has shortcomings. One such shortcoming arises due to the use of open collector signaling makes it very easy to connect a “listening” device to the communication and signaling wires to monitor communications between a card reader and an upstream device and thereby harvest data streams that can be used to compromise the system. Once a rogue device has been connected to monitor communications between the reader and an upstream device, an attacker can note when the door has been unlocked and record the most recent data stream as one that will open the door. Then, whenever illicit entry is desired, the attacker can replay the recorded data stream causing the door to unlock. The attacker need not remove the rogue device from the communication wires to gain unauthorized entry because of the Wiegand communications open collector data interface allows both the monitoring of messages and generation of messages from the same connection.

Furthermore, an attacker can harvest more than one valid message to gain unauthorized entry using different cardholder data so that no suspicions are aroused. Unauthorized access to the Wiegand communications wires is aided by the fact that at least one reader is typically deployed on the unsecured side of a wall or door and, because of the nature of access control, may be at a location that is not under continuous observation or scrutiny. Making matters worse, many access control readers do not include any tamper detection mechanisms so that the removal of a reader to access the internal wiring or even to replace the reader with another compromised reader or illicit device is undetectable. Even when tamper detection mechanisms are included in a reader, they are often not activated utilized because the installer of the reader does not want to incur the additional costs associated with installing additional wiring from the tamper detection mechanism back to the upstream device.

Certain weaknesses of the existing Wiegand protocol have been publicly exploited by hackers. One particular hacker has developed a device (known as the Gecko) that is capable of capturing and storing communications transmitted by a reader, and transmitting the stored communication at a later time thereby allowing unauthorized access to assets secured by the reader. This type of attack is known as a man-in-the-middle store-and-forward attack.

### SUMMARY OF THE INVENTION

The present invention is directed to anti-tampering device for electronic access control readers, including those that utilize the Wiegand Protocol. Specifically, the anti-tampering device prevents any attempts of tampering the original reader and execute a man-in-the-middle (MITM) attack. A common MITM attack involves splicing the internal wiring and inserting a device that facilitates the attack. Some card readers have tamper alarm switch outputs that can send a signal to the backend system if someone removes the reader's cover.

As such, the anti-tampering device is mounted near the control panel, if not inside a control panel box. It is installed in between the control panel and the access reader in order to prevent MITM attacks by severing power and data connections between the access reader and the control panel when someone tampers the access reader. Specifically, the present invention solves this problem by creating a system where the moment the tamper switch is triggered, any power or data coming in or out of the reader is disconnected, effectively rendering the reader useless to the potential attacker. This alarmed state will be permanently held, or “latched.” regardless of whether the reader tamper switch is brought back into its “normal” state. By disabling power and data connection from the reader to the controller access panel, any potential malicious data or signal will not be transmitted to the controller access panel, rendering any attempts to attack or spoof the system useless, thereby preventing the attack or subsequent attempts until the anti-tampering device is reset.

This present invention also includes alarm output notification features that can be used for connecting to security alarm monitoring systems, such as a burglar alarm system or electronic access control panel.

Most tamper switch alarm output signals are typically in the form of a 1-wire “open collector” format. This “open collector” signal is incompatible with most burglar alarm systems or electronic access control panels, which require 2-wire “dry contact” signals. This mismatch makes it directly impossible for most security systems to monitor those readers that use open collector tamper switches.

The present invention solves the incompatibility of these tamper switch signal mismatches, by converting the 1-wire “open collector” signal format to a compatible 2-wire “dry contact” signal.

In the preferred embodiment, an anti-tampering protection device is provided to prevent the hacking of access control reader devices, including but not limited to proximity and keycard card access entry readers, biometric and fingerprint authentication devices, and hand geometry and retinal scanners.

The anti-tampering protection device protects data line types including but not limited to Wiegand, OSDP, Clock & Data/ABA, RS232/RS485, F/2F, Match, XSF, and any reader using at least two-wires for data communications.

The anti-tampering protection device has several countermeasure features, including but not limited to neutralizing card sniffers, data loggers, and replay devices; nullifies edge-deployed “Man-in the Middle” (MITM) security hacking technologies such as the Gecko, BLE-Key, ESP-Key, and others that attack vulnerabilities in access systems; protecting controller panels from power manipulation tactics; safeguarding reader power and data lines against exploitations; providing local and remote tampering status indicators; and providing local and remote triggering and resetting.

Power manipulation tactics are defined as exploiting a remote, unsecured card reader panel by manually opening the cover and short-circuiting the power cables on the reader panel. In situations where the card reader is vulnerable, short-circuiting a single panel will result in a total loss of power on all the other connected panels as well as the security access box. The security panel is then subsequently will be fully disabled from the outside. In this state, horns will not sound off, and doors and emergency alarms will not be reported by the system, only an unsuspecting “COMM LOSS” message will be recorded in the security log. The anti-tampering device prevents such power manipulations attacks by providing a plurality of fuses that protect both the control panel and the anti-tampering device itself from power manipulation attacks.

Once the anti-tampering device is installed and activated, any attempt to tamper the access reader should trigger the anti-tampering device into a latched alarm state. In one embodiment, the anti-tamper device's LED will change from a “NORMAL” green to an “ALARM” red LED. When the anti-tampering device is in its ALARM state, the access reader's power and data connection will be severed, negating their chance of exploitation from the unsecured side of the door. Furthermore, during the ALARM state, the two relay outputs will engage, supplying additional monitoring or activation of triggering features.

Once the ALARM state is engaged, the system will latch on to the ALARM state until a system reset is performed. The system reset can be performed locally by pressing the reset button on the anti-tampering device, or alternatively if remote reset is enabled and configured, a remote reset may be triggered through the control panel via a host PC, application, mobile application, or other similar means.

The dip switch and multi configurability of the anti-tampering device bridges the gap between Reader and Control Panel compatibility across different types of readers and control panels. In practice, there are two common compatibility scenarios: (1) Most readers are equipped with either a Normally Closed (Single Wire) Tamper Switch signal, or a Normally Open (Single Wire) Tamper Switch signal, therefore necessitating a multi configurable anti-tampering device, and (2) the access readers need to be connected to electronic access control panels, but they cannot be connected due to an incompatible signal: Most control panels require 2 wire signals for status monitoring, but most readers only bear 1-wire signal outputs.

Due to the electronic circuit design of the anti-tampering device, the anti-tampering device is effectively a singular middleware module that accommodates the monitoring of either of these two reader tamper switch types, and permits these 2 types of signals to be converted into a format of which will be compatible to most, if not all electronic access control panels currently available in the field.

Without the compatibility feature, a 1-Wire NO Tamper Signal would be incompatible of being monitored by electronic access control panel, which requires 2-wire connection, and similarly, 1-Wire NC Tamper Signal is incompatible of being monitored by electronic access control panel, which requires 2-wire connection.

The anti-tampering device's configuration system solves the problem and as a result, said anti-tampering device converts the tamper signal such that a 1-wire NO Tamper Signal is converted into a 2-wire NO Tamper signal that can be monitored by the control panel that has a 2-wire connection requirement. Similarly, a 1-wire NC Tamper Signal is converted into a 2-wire NC Tamper Signal by the anti-tampering device such that the signal can be monitored by the control panel that has a 2-wire connection requirement.

Therefore, in the preferred embodiment, an anti-tampering device for electronic access control reader, comprising an input for data signal from an access control reader; an input for power from an access control reader; an input for tamper switch from an access control reader; at least one data output to an access control panel; at least one tamper alarm output to an access control panel; at least one fuse; at least one tamper switch controller; and a reset switch.

### BRIEF DESCRIPTION OF DRAWINGS

These and other features, aspects, and advantages of the present invention will become better understood with regard to the following descriptions, appended claims and accompanying drawings where:

FIG. 1 shows a diagram of a typical keycode access entry.

FIG. 2A shows a diagram of a typical biometric access entry.

FIG. 2B shows a diagram of a typical keycard access entry.

FIG. 3A and FIG. 3B show diagrams of a building with a keycard access with an intruder attempting to gain access by tampering with the keycard access reader.

FIG. 3C shows a close up of an intruder attempting to tamper with a keycard access reader by using a hand tool to forcefully open the keycard access reader front panel.

FIG. 4 shows a simple diagram of a typical Wiegand Security Panel system with a MITM reader hacking module attached to the wirings of the keycard access reader.

FIG. 5 shows a diagram of a smartphone with an app that connects to a MITM reader hacking module that allows the intruder to mimic authorized keycards and/or unlock the door.

FIG. 6A shows a diagram of a building's wiring system connecting the control panel and the keycard access readers, with the MITM module attack occurring at the access reader

FIG. 6B shows a diagram of a building's wiring system connecting the control panel and the keycard access readers, with the MITM module attack inside the building in the secured area portion of the building.

FIG. 7 shows a diagram of how a MITM attack can be used against a building's keycard access reader and the control panel by installing a MITM reader hacking module in between the keycard access reader panel and the control panel.

FIG. 8 shows a simple diagram of how a keycard access reader connects with the control panel and host PC.

FIG. 9 shows a simple diagram of how a MITM reader hacking module is inserted between the keycard access reader and the control panel.

FIG. 10 shows a simple diagram of how the anti-tampering device prevents MITM attacks by placing itself between the control panel and the MITM reader hacking module.

FIG. 11 shows one possible embodiment of the anti-tampering device.

FIG. 12 shows the anti-tampering device configured with a control panel and an integrated NO Tamper Switch.

FIG. 13 shows the anti-tampering device configured with a control panel and an integrated NC Tamper Switch.

FIG. 14 shows the anti-tampering device configured with a control panel and an external NO. Tamper Switch.

FIG. 15 shows the anti-tampering device configured with a control panel and an external NC Tamper Switch.

FIG. 16 shows a flow diagram illustrating the shows a flow diagram illustrating the different actions and functions based on the hardware involved in a typical building security system using keycard access reader systems on a normal state.

FIG. 17 shows a flow diagram illustrating the different actions and functions based on the hardware involved in a typical building security system using keycard access reader systems on an alarmed state.

FIG. 18 shows a flow diagram depicting the actions and functions of the lockdown module feature.

### REFERENCE NUMBER INDEX

100 Keycode Access Panel/Reader
102 Access reader with integrated tamper switch (N.O. OPEN COLLECTOR 1-WIRE OUTPUT)
104 Access reader with integrated tamper switch (N.C. OPEN COLLECTOR 1-WIRE OUTPUT)
106 Access reader with integrated tamper switch
107 Access reader with an external tamper switch
110 Biometric access reader
120 Keycard access reader
122 Cover plate with electronics enclosure
124 Screw socket
126 Back plate (wall mounted)
128 Tamper-detection contacts
130 Wires from access reader to control panel
132 Home run cable
134 Reader pigtail
136 Wire Splice Connections behind access panel
140 N.O. External Tamper Switch
142 N.C. External Tamper Switch
200 Authorized personnel
202 Keycard
250 Unauthorized personnel
252 Screwdriver or similar hand tool to remove an access panel
300 Building or secure access zone
310 Building entrance
312 Electronic door handle
314 Lock signal cable
320 Secured room within a building.
400 Hacking module
410 Processor
420 Transceiver Unit
430 Hacking module wires (with optional alligator clips) tapped into the access panel wires
450 Smartphone (or other device for communicating with the hacking module)
452 App for logging access data of authorized personnel
500 Control Panel
501 Signal output from control panel to unlock door
502 Power/Data Signals to/from Control Panel
504 Tamper signal output for control panel monitoring
506 Wiring for remote resetting of anti-tampering device by control panel
508 Wiring for remote triggering of anti-tampering device by control panel
520 Lock Power Supply
600 Anti-Tampering Device
610 7 position wire terminal to Control Panel (P1)
611 Power Input
612 Power Input
613 Data Communications Output
614 Data Communications Output
615 LED status input
616 LED status input
617 Shield/Ground
620 3-position wire terminal (P2)
621 Relay Output (Common)
622 Relay Output NO (Normal Open)
623 Relay Output NC (Normal Closed)
630 3-Position wire terminal P3
631 Relay Output 2 (Common)
632 Relay Output 2 NO (Normal Open)
633 Relay Output 2 NC (Normal Closed)
640 4-Position Wire Terminal P4
641 Remote Reset Input
642 Remote Reset Input
643 Remote Trigger Input
644 Remote Trigger Input
650 8-Position wire terminal P5
651 Power Output
652 Power Output
653 Data Communications Input
654 Data Communications Input
655 Red LED status output
656 Green LED status output
657 Shield/Ground
658 Tamper Input
660 Control Panel Fuse
661 Anti-Tampering Device Fuse
662 On-Board Relay 1
663 On-Board Relay 2
664 On-Board Relay 3
665 On-Board Relay 4
666 On-Board Relay 5
667 LED Alarm State
668 LED Normal State
669 Electronic Chip
670 Reset Switch
680 DIP Switch Array
682 Imprinted Legend to assist DIP switch setting array with NC Tamper.
684 Imprinted Legend to assist DIP switch setting array with NO Tamper.

### DETAILED DESCRIPTION OF THE PREFERRED EMBODIMENT

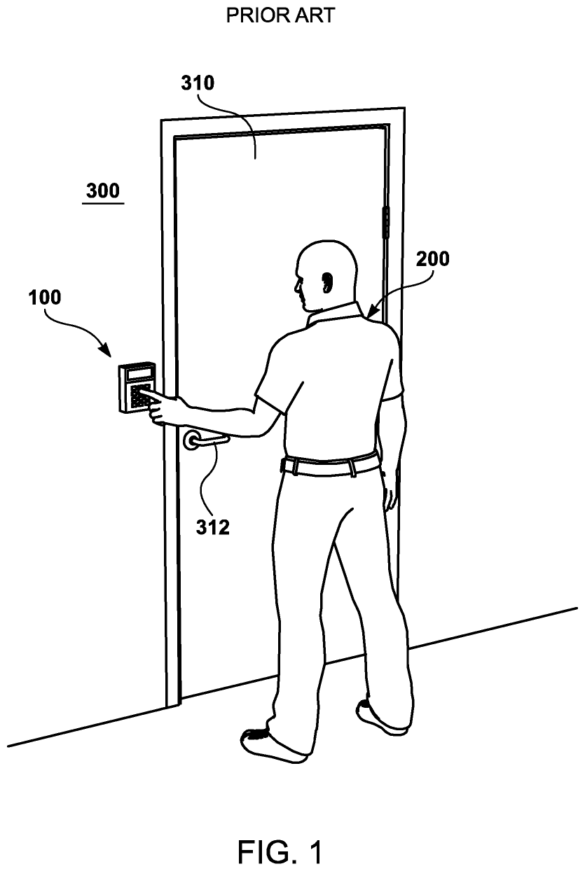

Looking at FIG. 1, in which a typical building or secure access zone 300 is equipped with a standard keycode access reader 100, an authorized person 200 can simply enter his credentials on the reader, and once the code has been accepted and credential electronically verified, said personnel may open the door by turning the electronic door handle 312 of the door 310 which will be unlocked for entry.

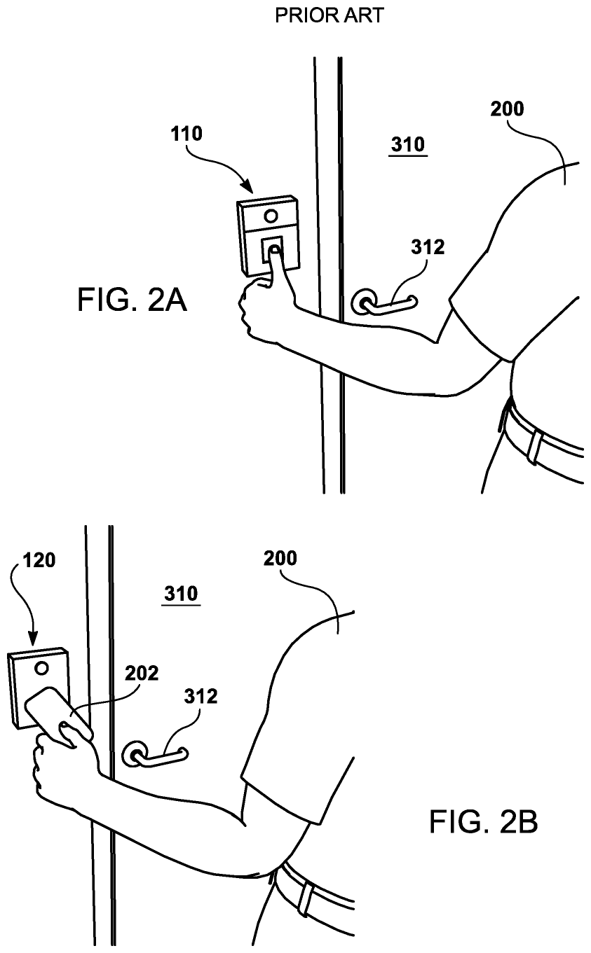

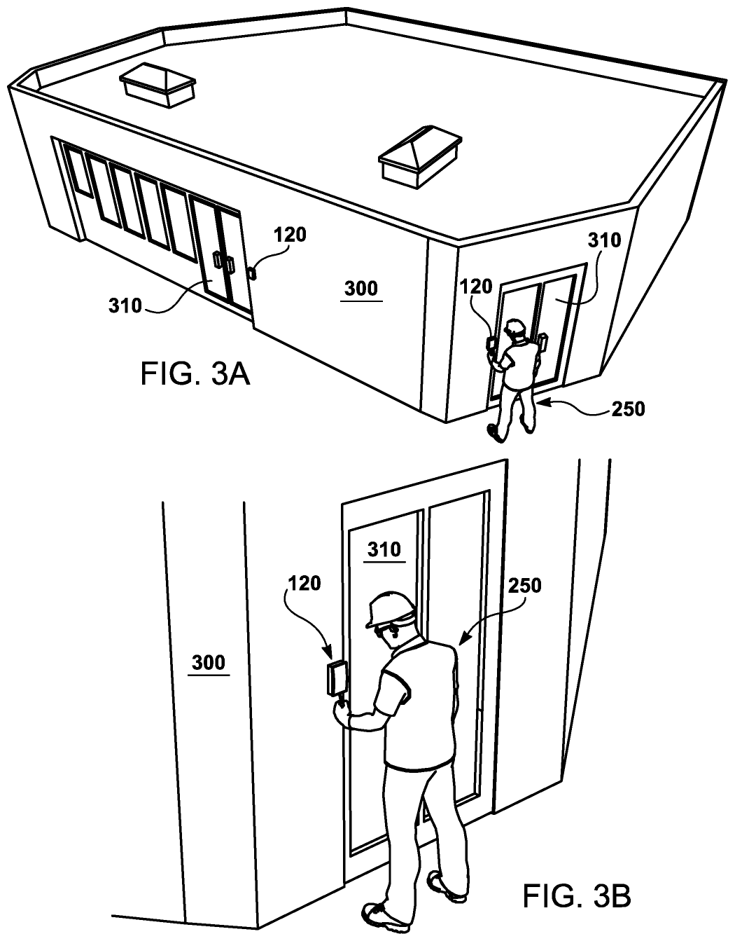

Looking at FIG. 2A, an alternate security configuration using a biometric access reader 110 in which the authorized person 200 enters a biometric information such as fingerprint, iris/retinal scan, or voice entry to unlock the electronic door handle 312 and open the door 310.

Looking at FIG. 2B, in which a door 310 is equipped with a keycard access reader 120, the authorized person 200 can tap or hover his keycard 202 in the vicinity of the keycard access reader to unlock the electronic door handle 312 and open the door 310.

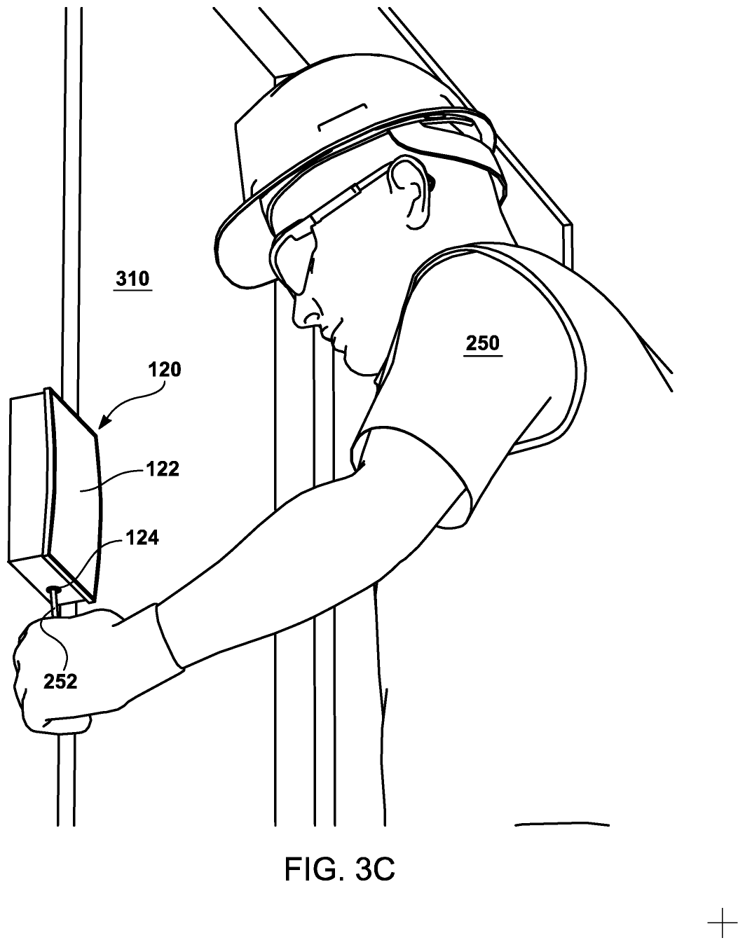

Looking at FIGS. 3A through 3C, in which an intruder 250 may attempt to gain access into a secured building/facility 300 with a plurality of doors 310, each is equipped with a keycard access reader 120 by tampering with the keycard access reader to overcome the security by exploiting known vulnerabilities to the system. In a typical, vulnerable keycard access reader configuration, an intruder may simply open the front panel 122 by inserting a screwdriver 252 or similar hand tool into the keycard access reader's screw hole 124, and once the reader is opened, the intruder is free to tamper the access reader to gain unauthorized access through the entrance without triggering any security alarm.

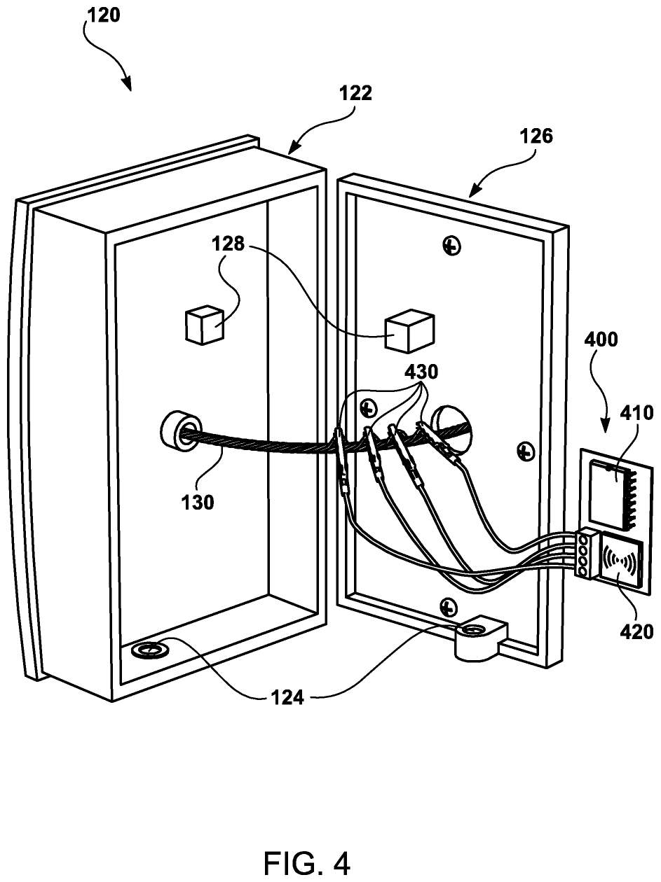

FIG. 4. shows an illustration of the inside of an opened keycard access reader 120, and how an intruder may exploit the vulnerability by connecting a hacking module 400 to the wires from access reader to interior control panel 130 and quickly bypass the security system. A typical hacking module is equipped with a processor 410 and a wireless transceiver 420 that can connect the module into a mobile device, where the intruder can capture absorbed data, program or execute the malicious code or app within the mobile device.

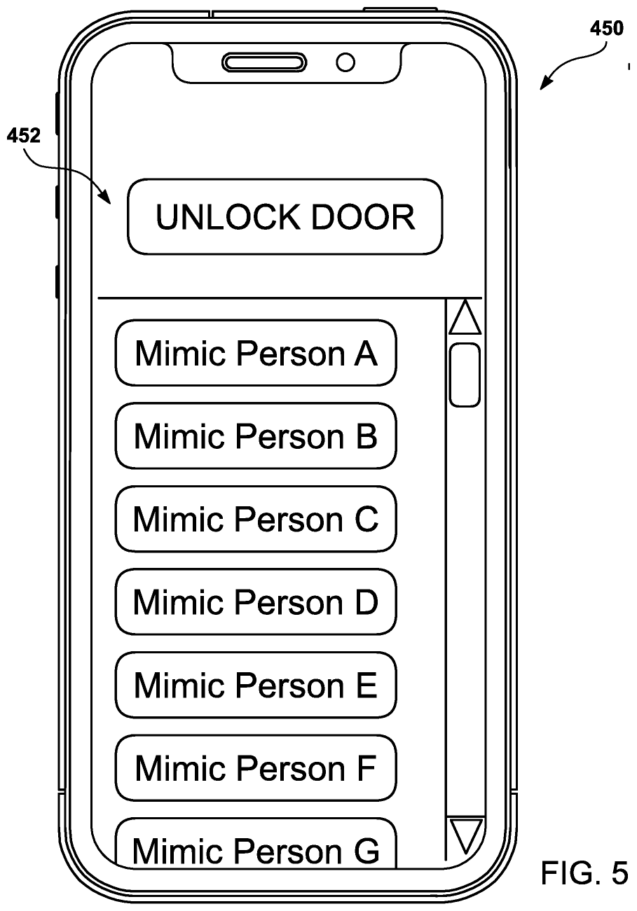

FIG. 5 shows a diagram of a hacking app on a mobile device 450 that may be used by an intruder once he or she tampers the device and connects the hacking module to the keycard access reader. Within the app, the intruder may spoof the credentials of an authorized personnel and unlock the door 452 using the fake credentials that is transmitted via the hacking module to the keycard access panel, thus fooling the keycard access reader that the door is being opened by authorized personnel. The absorbed person credential data can also be utilized in the creation of physical keycards which could also be used to gain access.

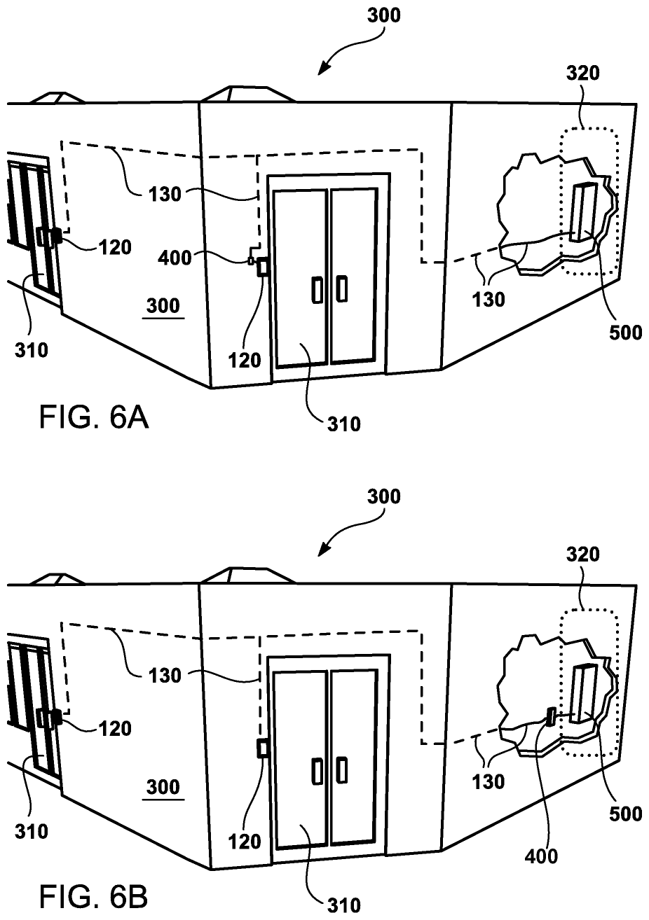

Looking at FIG. 6A, a building 300 with multiple door entrances 310 secured by multiple keycard access reader 120. The keycard access panels are connected by wires 130 to the interior control panel 500. The security panel 500 is typically installed inside a secure room 320 inside the building, typically in the center of the building or facility. In this figure, a Man-in-the-Middle (MITM) attack module 400 can be placed anywhere between the keycard access reader 120 and the security panel 500.

FIG. 6B shows an example of what is likely to be a case of an inside job, such that the intruder can somehow bypass the entrance, therefore attempting to install the MITM inside the building 300. For this attack to be possible, the perpetrator would only need to identify the proper cable leading out to an appropriate reader. They would not need to open the reader's cover, and hence the reader's tamper switch would not sense an attack, and would not trigger an alarm.

Nonetheless, anti-tampering device would still work in this situation: the alarm can still be triggered, and the anti-tampering device can still be latched into its alarmed and protective state. This is possible because the anti-tampering device also monitors the “home run cable” itself for tampering attempts. So long as the MITM module is implanted in between the access reader and the anti-tampering device, the fact is that the cable would still need to be “tapped” into in order to connect the MITM module. This means that the “home run cable” needs to be cut open, stripped, and spliced onto the 4 wire leads protruding out of the MITM module. And being that the anti-tampering device continuously monitors this home run cable for cuts, short circuits, or open circuits, the physical tampering of the cable will be detected by the anti-tampering device even in a worse-case scenario of an insider attack attempting to tamper the reader from the inside.

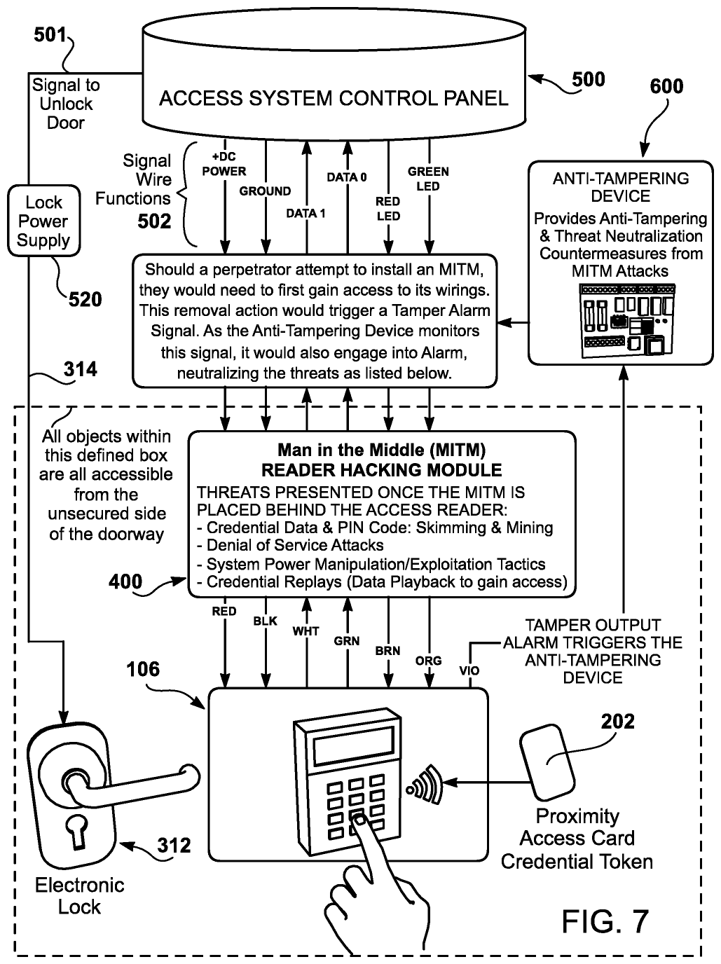

FIG. 7 illustrates one method of MITM attack that the anti-tampering device 600 can successfully prevent. One of the most common and cheap MITM attack is known as the ESP-Key. The ESP-Key is simply a small, programmable PIC chip with a wire connector on either side. Once it is connected to the wires behind the card reader, it allows the intruder to use a “replay” card or App to get through the door. Additionally, the intruder can also disable the system so that nobody else can come in behind the intruder if so desired.

The ESP-Key device is easy and cheap to manufacture, with hardware costs as low as $10. The ESP-Key hack subverts the Wiegand protocol, commonly used for communication between the card reader and the back end access control system, and does not take direct advantage of any problems with any of the hardware involved.

In a real-world situation, an intruder can quickly connect the reader wires onto the ESP-Key. The card reader will continue to work fine with the ESP-Key attached. It passes along the signal from the reader to the control system as it's supposed to. But when someone swipes an authorized card that unlocks the door, ESP-Key saves that signal.

With that saved unlock signal, the attacker can ‘replay’ that saved signal, and the door will unlock. What's more, any saved access logs would only show that the same person who originally swiped the saved signal swiped his card again.

Additionally, biometric devices use the Wiegand protocol as well and could also be vulnerable to an ESP-Key inserted behind it. For an ESP-Key to work well behind a high-security retina scanner, for example, the ESP-Key can include the ability for the device to accepts a wireless signal. In that case, the ESP-Key would save an authorized signal, and then replay that command when the attacker sent a wireless-signal from his or her mobile device—with no need to fake an eyeball.

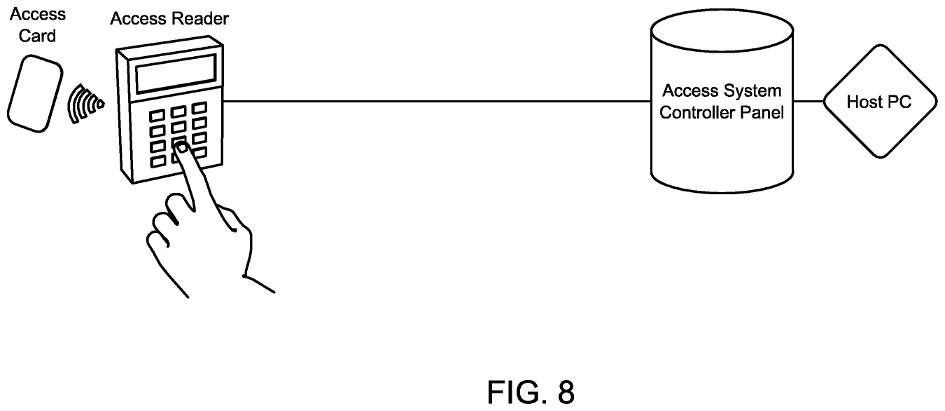

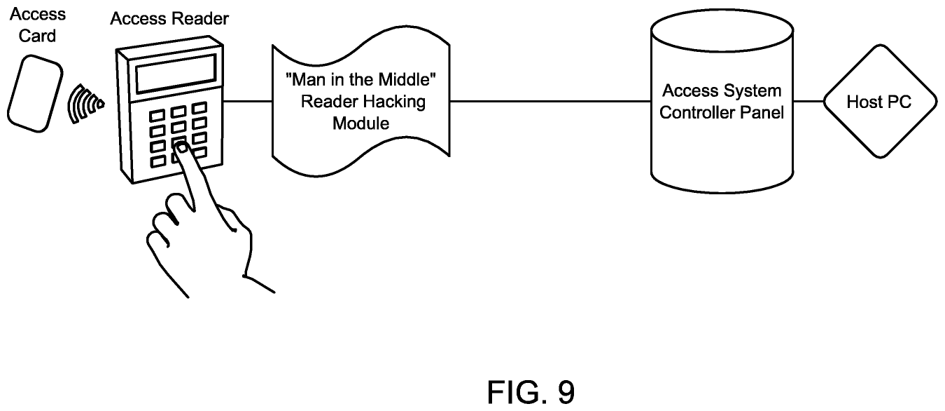

FIGS. 8-10 are simple diagrams to illustrate conceptually how a typical keycard access system is structured, where a MITM attack may be performed, and where an anti-tampering device can play a role in preventing such MITM attack. Looking at FIG. 8, a simplified diagram of a typical, vulnerable keycard access system where the access reader is connected directly to the security panel, which in turn is connected to a host PC to control and/or monitor.

Looking at FIG. 9, the diagram now shows how a MITM attack may occur by placing a MITM attack device or module in between the access reader and the control panel, therefore exploiting the vulnerability of the system.

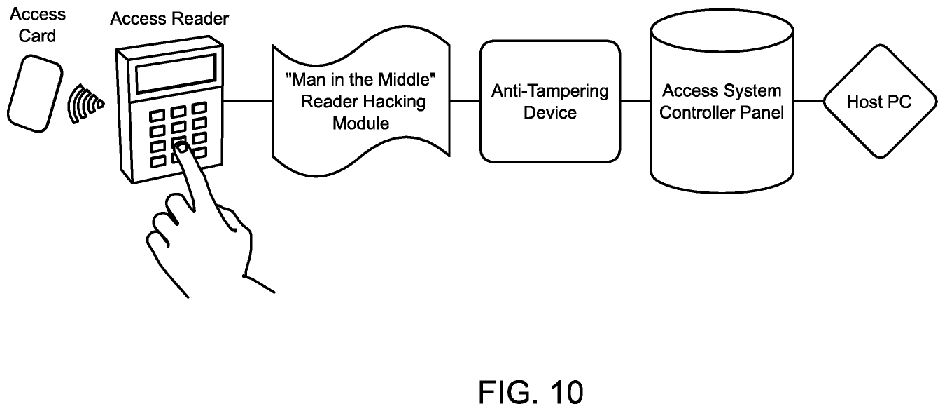

Looking at FIG. 10, the anti-tampering module is installed as close to the security panel as possible, to the extent that it may be mounted inside the security panel itself, such that it would effectively prevent any MITM attacks unless the intruder manages to directly access the security panel, which is typically located well inside the safest place in the building/facility.

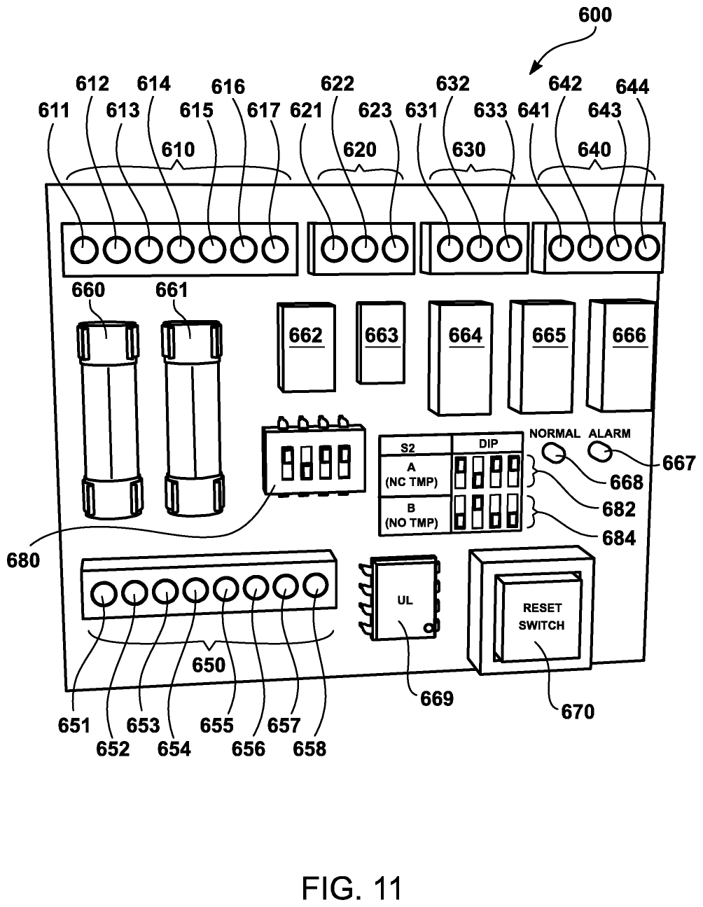

FIG. 11 shows a possible embodiment of the anti-tampering device 600 with its various parts. In a possible embodiment, the anti-tampering device is equipped with a plurality of wire connectors organized in groups. One such wire connector group, a 7-position wire terminal which in one embodiment is identified as “P1” 610, has two power inputs 611 and 612, two data communications output 613 and 614, two LED status input 615 and 616, and a shield/ground connector 617. All of these connectors are connected to the control panel inputs 502.

Another wire connector group, a 3-wire terminal which in one embodiment is identified as “P2” 620, has three relay output connectors, i.e. relay output (common) 621, relay output NO 622 for Normally Open (NO) tamper devices, and relay output NC 623 for Normally Closed (NC) tamper devices. These wire connector groups are connected to the tamper signal output for control panel monitoring 504. In an alternative embodiment, a second set of this identical 3-wire terminal group may be provided as group “P3” 630, which has the same set of outputs, namely relay output 2 (common) 631, relay output 2 NO 632 for Normally Open (NO) tamper devices, and relay output 2 NC 633 for Normally Closed (NC) tamper devices.

A 4-position wire terminal (P4) 640 is used for connecting remote reset inputs 641 and 642 to the control panel using wirings for remote resetting 504, and remote trigger inputs 643 and 644 from the control panel connected using wirings for remote triggering 506. The remote trigger and reset inputs allow authorized users to reset the anti-tampering device in the event a tamper event is triggered and the device needs to be reset into its normal state, or alternatively remotely trigger the lockdown function of the anti-tampering device.

A 8-Position wire terminal (P5) 650 connects the anti-tampering device to the access reader. In a typical setting, this terminal provides a pair of power output 651 and 652 (positive and negative), a pair of data communications input from the access reader 653 and 654 (DATA 0 and DATA 1), a red LED status output 655, a green LED status output 656, a shield/ground connector 657, and a tamper input from the access reader 658.

In a possible embodiment, at least two fuses are provided in the anti-tampering device to prevent power manipulation attacks. One fuse 660 protects the controller from power manipulation attacks, while another fuse 661 protects the anti-tampering device from power manipulation attacks, previously described in the summary section. Regardless of the tampering state, the control panel is continuously protected from possible “power manipulation” attempts via the onboard fuse 660.

Additional parts of the anti-tampering device include a plurality of On-Board Relays 662-665 that manage and control various features of the anti-tampering device, which includes switching from NORMAL state to ALERT state, severing power and data connections to the access reader during ALERT state, resetting the device, toggling alarm signals, and remote connections to the board to allow remote reset or activation. An electronic chipset 669 contains all the specific instructions that toggle the onboard relays. A reset switch 670 is provided to reset the anti-tampering device from its ALERT state back to NORMAL state.

In one embodiment, LED indicators 667 and 668 are provided to give visual indication of the state of the anti-tampering device. The normal LED state 667 is typically provided in green, while the alert state LED 668 is typically provided in red.

The installation of the anti-tampering device is crucial to maximizing the security and effectiveness of the device, such that in an ideal situation, the anti-tampering device should be mounted in a secure place that cannot be accessed by an intruder from outside the secure area. Power wise, the anti-tampering device draws minimal current, and is designed to utilize the 12V DC power source provided by the existing Control Panel. In the event that the control panel lacks the capability to produce sufficient power, then a separate 12V DC power source can be provided to ensure adequate power at all times.

A DIP Switch array 680 is provided to configure the anti-tampering switch so that it is universally compatible with various configurations of tamper switches, access readers, and control panels currently available in the field. A convenient imprinted Legend can also be provided on the anti-tamper device board for DIP switch setting array with NC tamper switches 682, or for settings with NO tamper switches 684.

Once the anti-tampering device is installed and activated, any attempt to tamper the access reader should trigger the anti-tampering device into a latched alarm state. In one embodiment, the anti-tamper device's LED will change from a “NORMAL” green to an “ALARM” red LED. When the anti-tampering device is in its ALARM state, the access reader's power and data connection will be severed, negating their chance of exploitation from the unsecured side of the door. Furthermore, during the ALARM state, the two relay outputs P2 and P3 will engage, supplying additional monitoring or activation of triggering features.

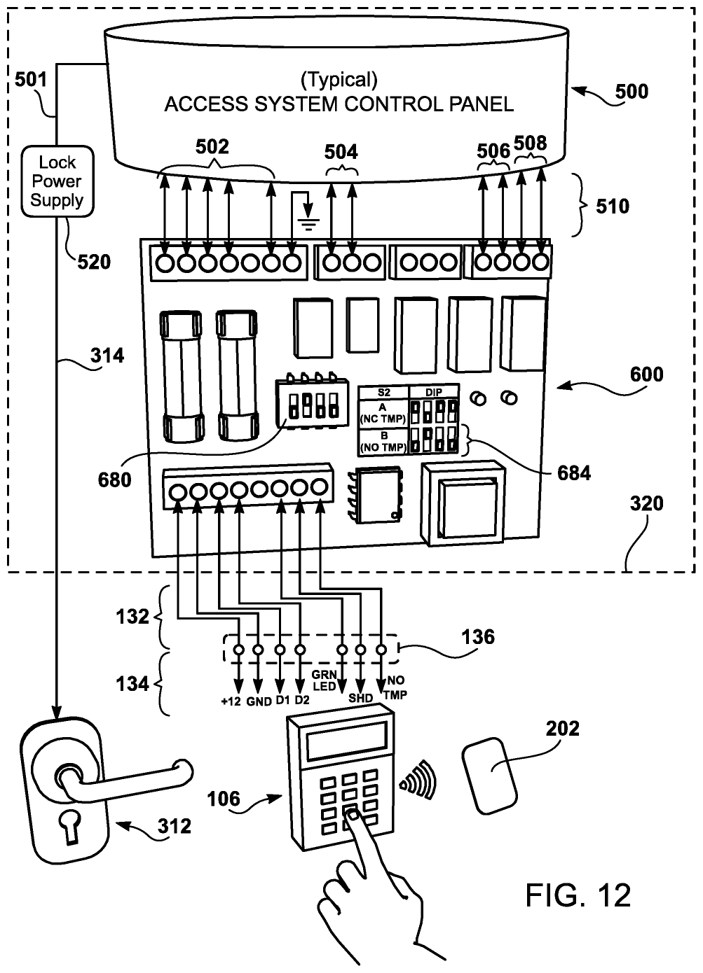

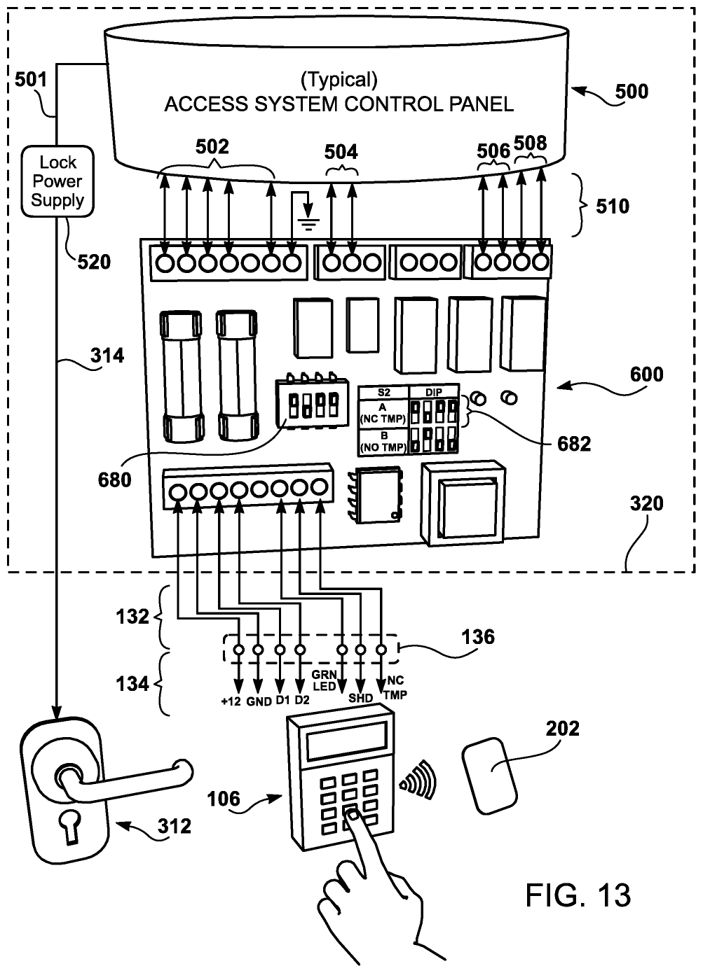

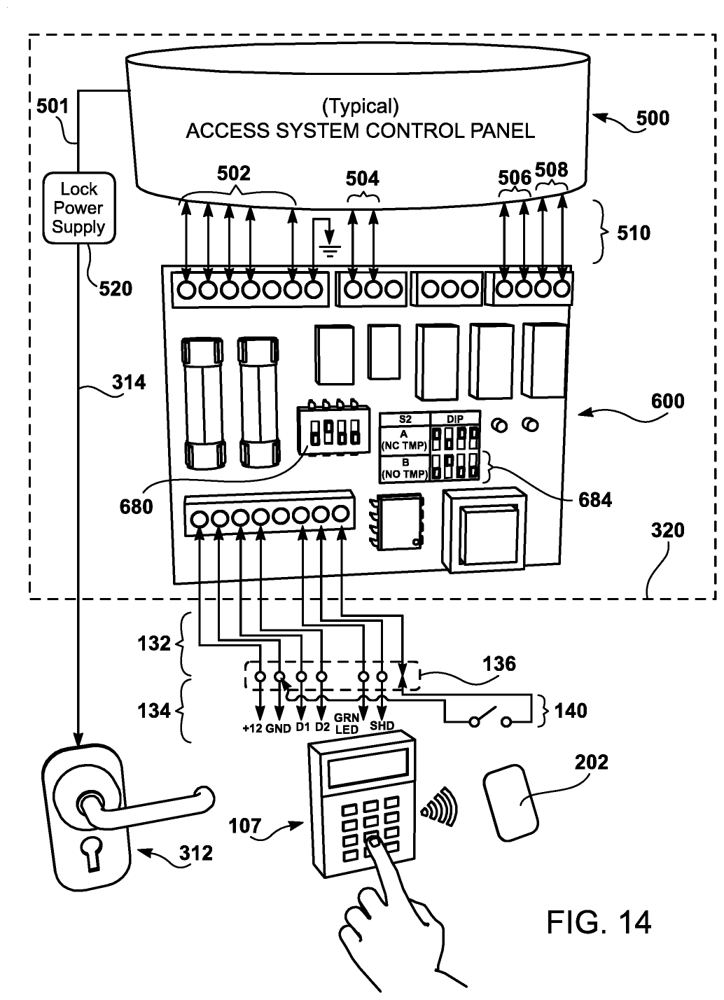

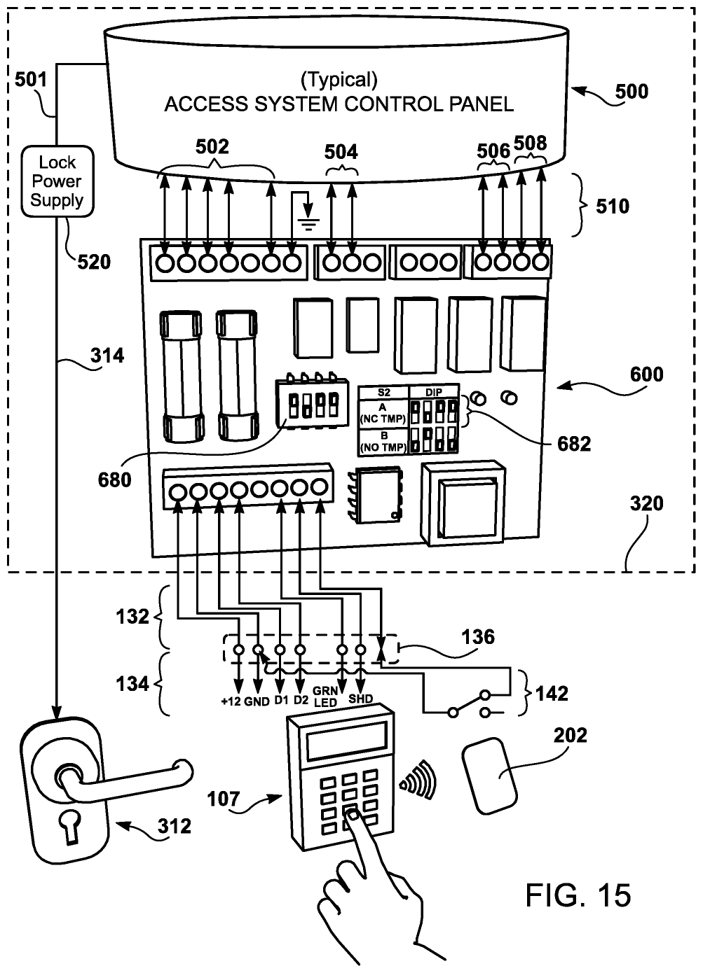

FIGS. 12 through 15 illustrate various scenarios of configuration based on the different types of Reader and Control Panel Compatibility. The different configurations can be summarized in the following table:

| | Internal/Built-In Tamper | Operation (Reader | Operation |
|---|---|---|---|
| FIG. No. | Switch Operations | in Normal State) | (Reader in ALERT State) |
| FIG. 12 | Access Reader has a (NO) | Tamper Wire is | Tamper Wire is “Closed |
| | 1-Wire Open Collector | “Open Circuit” to | Circuit” to Ground |
| | Tamper Output | Ground | |
| FIG. 13 | Access Reader has a (NC) | Tamper Wire is | Tamper Wire is “Open |
| | 1-Wire Open Collector | “Closed Circuit” to | Circuit” to Ground |
| | Tamper Output | Ground | |

| | External Tamper Switch | Operation (Reader | Operation |
|---|---|---|---|
| FIG. No. | Operations | in Normal State) | (Reader in ALERT State) |
| FIG. 14 | External Switch has an | Tamper Wire is | Tamper Wire is “Closed |
| | (NO) 2-wire “Dry Contact” | “Open Circuit” to | Circuit” to Ground |
| | Tamper Output | Ground | |
| FIG. 15 | External Switch has an (NC) | Tamper Wire is | Tamper Wire is “Open |
| | 2-wire “Dry Contact” | “Closed Circuit” to | Circuit” to Ground |
| | Tamper Output | Ground | |

FIG. 12 depicts a configuration in which the Access Reader has an integrated tamper wire output 106, i.e. a (NO) 1-Wire Open Collector Tamper Output. In this configuration, the control panel 500 is connected to the anti-tamper device through the various connectors, and the control panel is connected through a lock power supply 501 which in turn powers and sends the unlock signal to the electronic door lock 312. The anti tamper device is also connected with the reader access panel through the “home run” cable from the reader, which would usually be connected to the control panel if the anti tamper device is not installed. All the connections from the reader may be connected using a pig tail wire 134. The wire splice configuration 136 corresponds to the various connectors previously identified in the anti-tamper device, including power lines, ground, data connectors, LED connectors, and tamper cables to the reader. In this configuration, the DIP switch array 680 is configured for NO tamper switch setting 684.

FIG. 13 depicts a configuration in which the Access Reader has an integrated tamper wire output 106, i.e. (NC) 1-Wire Open Collector Tamper Output. The configuration is substantively identical to the configuration with the NO tamper switch previously depicted in FIG. 12, other than the DIP switch array 680 is configured with the corresponding NC tamper switch mode 682.

FIG. 14 depicts a configuration in which the access reader with an external tamper switch output 107, such that an external tamper switch is required. In this case, the external tamper switch has an (NO) 2-wire “Dry Contact” Tamper Output. The configuration is substantively identical to the configuration with the NO tamper switch previously depicted in FIGS. 12 and 13, with the difference being that the tamper switch is located externally rather than internally, with the NO External Tamper Switch 140 being configured with the DIP switch array 680 for NO tamper switch setting 684.

FIG. 15 depicts a configuration in which the access reader with an external tamper switch output 107, such that an external tamper switch is required. In this case the external tamper switch has an (NC) 2-wire “Dry Contact” Tamper Output. The configuration is substantively identical to the configuration previously depicted in FIGS. 12, 13, and 14 with the difference being that the tamper switch is located externally rather than internally, with the NC External Tamper Switch 140 being configured with the DIP switch array 680 for NC tamper switch setting 682.

The DIP switch and multi configurability of the anti-tampering device bridges the gap between Reader and Control Panel compatibility across different types of readers and control panels. In practice, there are two common compatibility scenarios: (1) All readers are equipped with either a Normally Closed (Single Wire) Tamper Switch signal, or a Normally Open (Single Wire) Tamper Switch signal, therefore necessitating a multi configurable anti-tampering device, or (2) the access readers need to be connected to electronic access control panels, but they cannot be connected due to an incompatible signal. Many control panels require 2 wire signals for status monitoring, but some readers only bear 1-wire signal outputs.

Due to the electronic circuit design of the anti-tampering device, the anti-tampering device is effectively a singular middleware module that accommodates the monitoring of either of these two reader tamper switch types, and permits these 2 types of signals to be converted into a format of which will be compatible to most, if not all electronic access control panels currently available in the field.

Without the compatibility feature, a 1-Wire NO Tamper Signal would be incompatible of being monitored by electronic access control panel, which requires 2-wire connection, and similarly, 1-Wire NC Tamper Signal is incompatible of being monitored by electronic access control panel, which requires 2-wire connection.

The anti-tampering device's configuration system solves the problem and as a result, said anti-tampering device converts the tamper signal such that a 1-wire NO Tamper Signal is converted into a 2-wire NO Tamper signal that can be monitored by the control panel that has a 2-wire connection requirement. Similarly, a 1-wire NC Tamper Signal is converted into a 2-wire NC Tamper Signal by the anti-tampering device such that the signal can be monitored by the control panel that has a 2-wire connection requirement.

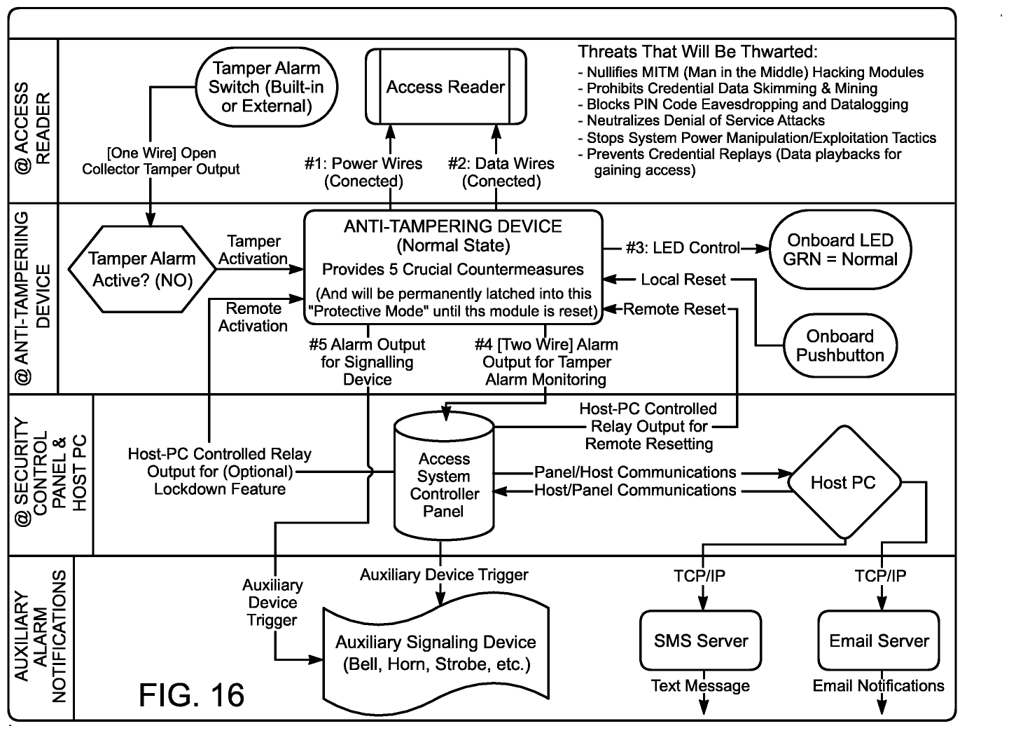

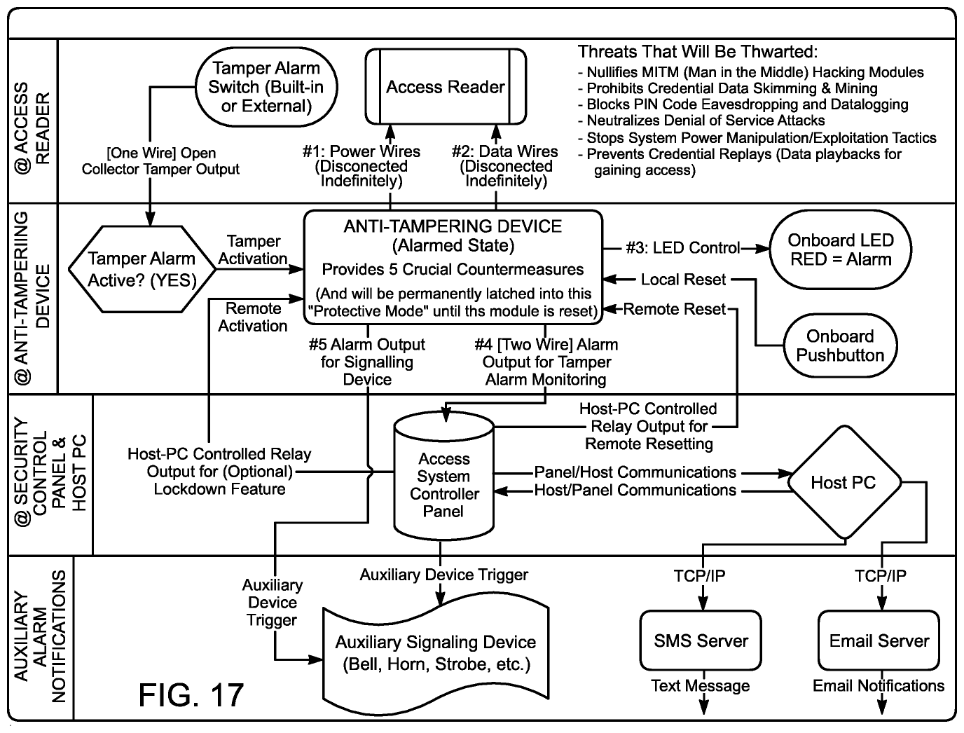

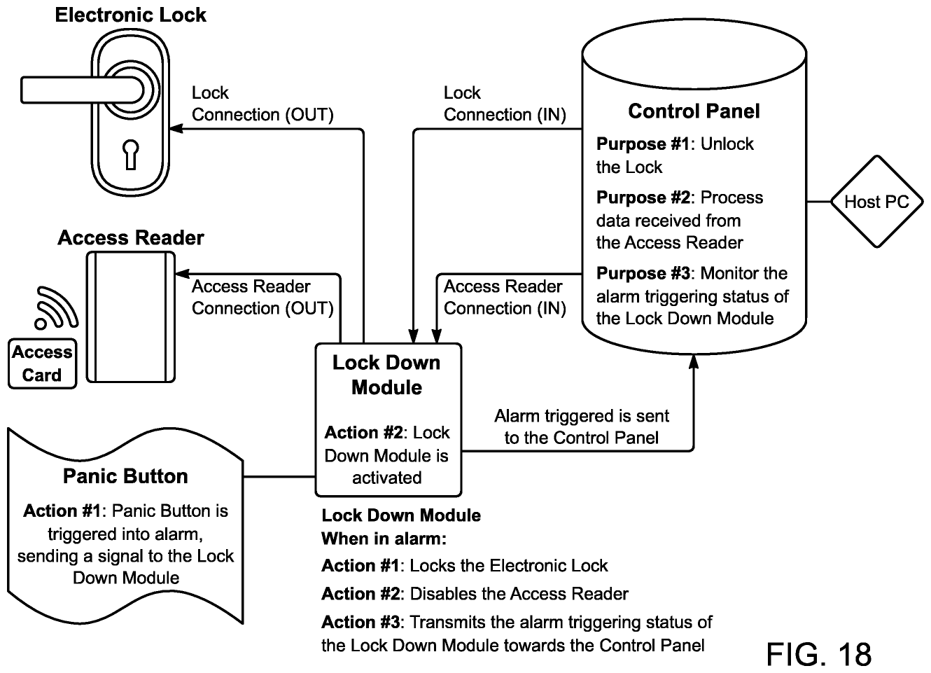

FIGS. 16 and 17 are diagrams depicting the overall system in two different states. FIG. 16 illustrates the system in its entirety in NORMAL state, and FIG. 17 illustrates the system in its entirety in its triggered ALERT state. Both diagrams summarize the functions and the actions taken in between the states, and once the system is reset, the system returns to the NORMAL state depicted in FIG. 16 until a tampering incident is detected and thus entering the ALERT state depicted in FIG. 17.

Looking at FIG. 18, a diagram of the lockdown module of the anti-tampering device is disclosed. More specifically, the lockdown module allows a panic button function that can be triggered by an authorized security personnel or other person who needs to lockdown the building and/or facility during an emergency situation. A most common situation would be when there is an attempted robbery and/or active shooter, in which the intruder needs to be prevented from entering the building or alternatively, isolate the intruder to prevent further intrusion while help is on the way. In the preferred embodiment, when a user activates the panic button, the button sends a signal to the lockdown module and activates the lockdown module. The lockdown module in turn then locks all the electronic locks or any locks preconfigured to be locked during a panic button activation, disables all access reader until the lockdown has been lifted, and transmits the alarm triggering status of the lockdown module towards the control panel. Once the threat has been assessed and/or neutralized, the lockdown module can be lifted by accessing the control panel and/or the anti-tampering device and by resetting the device.

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Although the present invention has been described in considerable detail with reference to certain preferred versions thereof, other versions are possible. Therefore, the spirit and scope of the appended claims should not be limited to the description of the preferred version contained herein.

We claim:

1. An anti-tampering device for electronic access control reader, comprising:
a. At least one input for data signal from an access control reader;
b. At least one input for power from an access control reader;
c. At least one input for tamper switch from an access control reader;
d. At least one data output to an access control panel;
e. At least one tamper alarm output to an access control panel;
f. At least one fuse;
g. At least one tamper switch controller; and
h. A reset switch.

2. An anti-tampering device for electronic access control reader of claim 1, further comprising at least one visual LED status indicator.

3. An anti-tampering device for electronic access control reader of claim 1, further comprising a lockdown controller.

4. An anti-tampering device for electronic access control reader of claim 3, where said lockdown controller can be triggered remotely.

5. An anti-tampering device for electronic access control reader of claim 1, where said reset switch can be triggered remotely.

6. An anti-tampering device for electronic access control reader of claim 1, further comprising a remote reset output.

7. An anti-tampering device for electronic access control reader of claim 1, further comprising a remote trigger output.

8. An anti-tampering device for electronic access control reader of claim 1, where the tamper switch controller is compatible with access readers that has a (NO) 1-Wire Open Collector Tamper Output.

9. An anti-tampering device for electronic access control reader of claim 1, where the tamper switch controller is compatible with access readers that has a (NC) 1-Wire Open Collector Tamper Output.

10. An anti-tampering device for electronic access control reader of claim 1, where the tamper switch controller is compatible with access readers equipped with external tamper switch has an (NO) 2-wire tamper output.

11. An anti-tampering device for electronic access control reader of claim 1, where the tamper switch controller is compatible with access readers equipped with external tamper switch has an (NC) 2-wire tamper output.
